(19) United States
(12) Patent Application Publication
(10) Pub. No.: US 2020/0381189 A1
(43) Pub. Date: Dec. 3, 2020

(54) KEY UNIT, AND KEYBOARD USING KEY UNITS

(71) Applicant: Shenzhen New KuSi Electronic Technology Co., Ltd., Shenzhen (CN)

(72) Inventor: Wen-yu ZHANG, Shenzhen (CN)

(21) Appl. No.: 16/999,162

(22) Filed: Aug. 21, 2020

Related U.S. Application Data
(63) Continuation of application No. PCT/CN2019/075972, filed on Feb. 22, 2019.

(30) Foreign Application Priority Data
Feb. 22, 2018 (CN) 201820262528.X
Dec. 10, 2018 (CN) 201822076854.4

(51) Int. Cl. H01H 3/12; G06F 3/02; H01H 13/84

(52) U.S. Cl. CPC H01H 3/122; H01H 13/84; G06F 3/0202

(57) ABSTRACT

The present disclosure discloses a key unit. The key unit comprises a movable body, an elastic body, and a switch layer comprising a plurality of control switches that are arrayed, wherein along a vertical direction, one end of the elastic body is abutted against a non-central region of the movable body, the other end of the elastic body is selectively pressed against the switch layer under pressing drive of the movable body to adjust an operating state of the control switches of the switch layer. In addition, the present disclosure further provides a keyboard which employs arrays of the key units. With the keyboard unit according to the present disclosure, the quantity of elements is reduced, the structure is simplified, the assembling is facilitated, and the dust-proofing performance is improved.

### TECHNICAL FIELD

The present disclosure relates to an electronic input device, and in particular, relates to a key unit, and a keyboard using key units.

### BACKGROUND

With the development of modern electronics technologies, electronic products are becoming more and more indispensable in people's life. Various electronic products, such as telephones, mobile phones, remote controls, laptop computers, and desktop computers are commonly used. Key units, as a mainstream input device for the above electronic products, are playing an important role. Tactile sensation of the key units greatly affects the input experience of the electronic products.

In the related art, in the structure of the key unit having a pressable switch layer, a silica gel elastic body or a spring is disposed under a movable body to press the switch layer to implement the switch function.

However, the related still has the following defects:

First, the silica gel elastic body has poor tactile sensation, and a linear press curve may not be achieved.

Second, although the spring is capable of achieving linear tactile sensation like a mechanical key, in the structure where the spring is disposed under the movable body, for accommodation of the spring in the movable body, the movable body has to be split into two portions, the spring is firstly placed in the movable body, and then the two portions are spliced by hot melting, or riveting, snapping or the like process. Such a structure fails to achieve integral injection molding of the movable body, thereby the cost is to be increased. At the same time, since the movable body is divided into two individual parts, the structural strength of the movable body is significantly weakened after the two parts are spliced by assembling, and when the top of the movable body is subjected to a great press force or torque, the movable body has a risk of disintegration.

Further, when the key unit array is disposed to form an input device such as a keyboard, in the industry, a first housing and a second housing generally need to be provided, and the key unit is received in a receiving space enclosed by the first housing and the second housing. At the same time, an additional part as the third part is provided to lock the second housing and the second housing together, and fix the key unit therein.

A plurality of key units may be fixed by such method, which has the following defects:

Defect 1: Since the screw is rotated to lock the housings, in the actual assembly process, the parallelism tolerance between a key supporting plate and a thin-film supporting plate differs depending on the screw in assembly force controlled by human or assembly machine, and such assembly process might create the deformation to the housings, and then results in inconsistent spacing between the key supporting plate and the thin-film supporting plate.

Defect 2: Due to lack of support between the key supporting plate and the thin-film supporting plate, an extra press to keyboard could make the housing deformed in some degree, and induce the inconsistent space between the switch layer and the key supporting plate and the thin-film supporting plate, thereby resulting in unstable trigger.

Defect 3: Due to the need of additional screws to lock and fix the housings, the components and the cost are to be increased and the assembly process becomes complicated.

Therefore, a key unit having a new structure and an input device are urgently desired to solve the above problems.

### SUMMARY OF THE INVENTION

In order to solve the above technical problems, the present invention provides a key unit which is simple in structure, convenient to assemble, high in pressing precision, and long in life.

At the same time, the present invention also provides a key array and an input device using the above key unit.

A key unit, comprising: a movable body, an elastic body and a switch layer comprising a plurality of control switches that are arrayed, wherein along a vertical direction, one end of the elastic body is abutted against a non-central region of the movable body, the other end of the elastic body is selectively pressed against the switch layer under pressing drive of the movable body to adjust an operating state of the control switches of the switch layer.

In a preferred embodiment of the key unit provided by the present invention, wherein the movable body comprises a stroke guiding post disposed in a central region thereof, the movable body is reciprocatable along an extension direction of the stroke guiding post, and the elastic body is not overlapped with a central axis of the stroke guiding post in the vertical direction.

In a preferred embodiment of the key unit provided by the present invention, wherein the housing comprises a stroke guiding tube, the stroke guiding tube and the stroke guiding post being correspondingly nested and freely slidable upward and downward relative to each other.

In a preferred embodiment of the key unit provided by the present invention, wherein the movable body comprises the stroke guiding post and the side wall, and in the vertical direction, the stroke guiding post is disposed at a center position of the movable body or at a slightly off-center position, and the side wall encloses a receiving space with an opening, the receiving space being disposed on an outer side of the stroke guiding post, the elastic body being movably nested at the opening.

In a preferred embodiment of the key unit provided by the present invention, wherein the movable body comprises a stroke guiding tube disposed in a central region thereof, the movable body is reciprocatable along an extension direction of the stroke guiding tube, and the elastic body is not overlapped with a central axis of the stroke guiding tube in the vertical direction.

In a preferred embodiment of the key unit provided by the present invention, further comprising a housing, wherein the housing comprises a stroke guiding post, the stroke guiding post and the stroke guiding tube being correspondingly nested and freely slidable upward and downward relative to each other.

In a preferred embodiment of the key unit provided by the present invention, wherein the movable body comprises a stroke guiding tube and a side wall, the side wall being fixedly connected to one end of the elastic body.

In a preferred embodiment of the key unit provided by the present invention, wherein the movable body comprises the stroke guiding tube and the side wall, and in the vertical direction, the stroke guiding tube is disposed at a center position of the movable body or at a slightly off-center position, and the side wall encloses a receiving space with an opening, the receiving space being disposed on an outer side of the stroke guiding tube, the elastic body being movably nested at the opening.

In a preferred embodiment of the key unit provided by the present invention, wherein the elastic body comprises a spring and an abutting body, the spring being received in the receiving space enclosed by the side wall, one end of the spring being elastically abutted against the abutting against, the abutting body being selectively pressed against the switch layer.

In a preferred embodiment of the key unit provided by the present invention, wherein the elastic body comprises an integrally-molded silica gel post, one end of the silica gel post being abutted against the non-central region of the movable body, the other end of the silica gel post being selectively pressed against the switch layer.

In a preferred embodiment of the key unit provided by the present invention, wherein the abutting body comprises a side wall, a connecting portion, and an abutting portion that are connected, the side wall of the abutting body and the side wall of the movable body being nested, the abutting portion being selectively pressed against the switch layer.

In a preferred embodiment of the key unit provided by the present invention, wherein the side wall of the movable body comprises a sliding groove, and the abutting body comprises a sliding block, the sliding block being disposed on a side surface of the abutting body, the sliding block being in cooperation with the sliding groove to push the abutting body to move upward and downward along an extension direction of the sliding groove.

In a preferred embodiment of the key unit provided by the present invention, wherein the other end of the connecting portion is connected to a slope of the abutting portion in a transition fashion.

In a preferred embodiment of the key unit provided by the present invention, wherein the elastic body further comprises a package, the package comprising a cover, a first clasp, and a second clasp, the first clasp and the second clasp being respectively disposed on two opposite sides of the cover, the first clasp and the second clasp being correspondingly latched and fixed to the side wall of the movable body, the package being in cooperation with the side wall of the movable body to enclose a receiving space with an opening, the elastic body being correspondingly received in the receiving space, one end of the elastic body being abutted against an inner side surface of the cover of the package.

In a preferred embodiment of the key unit provided by the present invention, wherein the housing comprises an upper cover and a lower cover that are latched and fixed to each other, the lower cover comprising a through hole, the abutting portion of the abutting body passing through the through hole and being selectively pressed against the switch layer.

In a preferred embodiment of the key unit provided by the present invention, further comprising an elastic plate, wherein the elastic plate is sandwiched between the first movable body and the housing.

A key unit includes a housing with an accommodation space, a movable body, an elastic body and a switch layer, the elastic body being received in the housing, one end of the movable body passing through the housing, the other end of the movable body being received in the housing, wherein the movable body and the housing are nested and assembled under cooperation between a stroke guiding post and a stroke guiding tube, and in a vertical direction, the movable body is movable upward and downward relative to the housing to define an upward stroke and a downward stroke, and up and down movements of the movable body drive the elastic body to selectively trigger the switch layer.

In a preferred embodiment of the key unit provided by the present invention, wherein the elastic body is disposed at a side position of the housing, and the movable body is disposed at a center position of the housing.

In a preferred embodiment of the key unit provided by the present invention, wherein the stroke guiding post and the stroke guiding tube are respectively correspondingly disposed on the movable body and the housing, or the stroke guiding post and the stroke guiding tube are respectively correspondingly disposed on the housing and the movable body.

In a preferred embodiment of the key unit provided by the present invention, wherein the stroke guiding post and the stroke guiding tube are respectively correspondingly disposed on the housing and the movable body.

In a preferred embodiment of the key unit provided by the present invention, wherein in the vertical direction, a central axis of the elastic body and central axes of the stroke guiding post and the stroke guiding tube are not in the same straight line.

An input device comprising a plurality of arrayed key units, the key unit comprising a movable body, an elastic body and a switch layer of a plurality of control switches, wherein one end of the elastic body abuts the movable body in a vertical direction The non-central region, the other end is selectively pressed against the switch layer under the driving of the movable body to adjust the working state of the control switch of the switch layer.

A key array includes a first base plate and a second base plate each having arrayed through holes, and a plurality of arrayed key units, the first base plate and the second base plate being laminated, one ends of the key unit correspondingly passing through the through holes in the first base plate and being abut against or approaching an inner side surface of the second base plate, wherein the first base plate and the second base plate are directly physically bonded and fixed to enclose a receiving space configured to receive a portion of the key units, the key unit comprising a movable body, an elastic body and a switch layer of a plurality of control switches, wherein one end of the elastic body abuts the movable body in a vertical direction The non-central region, the other end is selectively pressed against the switch layer under the driving of the movable body to adjust the working state of the control switch of the switch layer.

In a preferred embodiment of the key array provided by the present invention, wherein the first base plate comprises a body and a side wall, the body and the second base plate being oppositely disposed, the side wall extending from the same side of an edge of the body to define an opening, the second base plate being received in the opening, the side wall and an edge of the second base plate being fixed to each other by a clasp.

In a preferred embodiment of the key array provided by the present invention, wherein an inner side surface of the side wall of the first base plate is provided with a clasp, the clasp comprising an outer edge and a bottom surface of the second base plate.

In a preferred embodiment of the key array provided by the present invention, wherein the first base plate further comprises a supporting wall, the supporting wall being sandwiched between the body of the first base plate and the second base plate.

In a preferred embodiment of the key array provided by the present invention, wherein the supporting wall is integrally molded with the body, and is defined by extending from a surface of the body towards the second base plate.

In a preferred embodiment of the key array provided by the present invention, further comprising a switch layer sandwiched between the key units and the second base plate, wherein the supporting wall is abutted against the switch layer, and configured to fix the switch layer between the key units and the second base plate.

A keyboard, comprising a first base plate and a second base plate each having a plurality of through holes, and a plurality of key units, the first base plate and the second base plate being spaced apart from each other, the key units being abutted against or approaching an inner side surface of the second base plate by the through holes, wherein the key unit comprises the key unit as defined in claim 1 or 18, and the first base plate comprises a side wall, the side wall being fixed to an edge of the second base plate by a clasp structure.

In a preferred embodiment of the keyboard provided by the present invention, wherein the first base plate further comprises a supporting wall, the supporting wall being sandwiched between the body of the first base plate and the second base plate.

An input device, comprising a first housing, a second housing, and a key array, wherein the first housing is in cooperation with the second housing to enclose a receiving space configured to receive the key array, and the key array comprises a first base plate, a second base plate, and a plurality of arrayed key units, the first base plate and the second base plate being oppositely disposed and being fixed and assembled by a physical clasp structure, one end of the key unit extending out of the first base plate, the other end of the key unit passing through the first base plate and being disposed to approach or be abutted against an inner side surface of the second base plate, the key unit comprising a movable body and a housing, the movable body and the housing being assembled under cooperation of a stroke guiding post and a stroke guiding tube such that the movable body is movable upward and downward in a vertical direction relative to the housing.

In a preferred embodiment of the input device provided by the present invention, wherein the stroke guiding post is disposed on the movable body, and the stroke guiding tube is disposed on the housing, or the stroke guiding post is disposed on the housing, and the stroke guiding tube is disposed on the movable body.

In a preferred embodiment of the input device provided by the present invention, wherein the first base plate and the second base plate are fixed and assembled under cooperation of a clasp.

In a preferred embodiment of the input device provided by the present invention, further comprising an elastic body, wherein the elastic body is disposed on a side surface of the housing.

A method for assembling a key unit, comprising: providing a movable body, the movable body comprising an outer side of a stroke guiding tube; providing a first spring, the first spring being sleeved onto the stroke guiding tube; and providing a lower cover, the lower cover comprising a stroke guiding post, the stroke guiding post being nested and assembled corresponding to a central region of the stroke guiding tube, such that the first spring is sleeved onto outer sides of the stroke guiding post and the stroke guiding tube.

In a preferred embodiment of the method for assembling a key unit provided by the present invention, further comprising an elastic body, wherein the elastic body is disposed on a side surface of the movable body, and one end of the elastic body is fixed to the movable body, and is movable upward and downward in a vertical direction under driving of the movable body.

In a preferred embodiment of the method for assembling a key unit provided by the present invention, further comprising a switch layer, wherein the elastic body is selectively abutted against the switch layer in the vertical direction under driving of the movable body.

Compared with the related art, in the key unit according to the present disclosure, the side wall of the movable body is in cooperation with the package to enclose the receiving space configured to receive end portions of the elastic body and the abutting body, and the receiving space is disposed on the side surface of the movable body. This structure achieves the following technical effects:

First, the package is employed to package the elastic body into the receiving space, which facilitates replacement of the moving body, and effectively achieves a dust-proofing effect. Then, the side wall of the movable body is directly used as a stroke guiding support for the abutting body, which simplifies the structure, reduces the quantity of elements, and facilitates the assembling. Since the movable body and the side wall thereof are integrally molded, the abutting body may be effectively supported by the movable body, which improves the product reliability. The elastic body is disposed on the side surface of the stroke guiding post, instead of being disposed directly under the stroke guiding post, which facilitates upward and downward movements in the vertical direction, provides a relatively consistent force to the stroke guiding post, addresses the defects that the press process is not smooth due to the effect of dispersed forces and the movable body of the key unit is jammed. In this way, the tactile sensation and reliability of the key unit are improved.

Second, the first base plate and the second base plate are directly physically bonded by a clasp structure, which prevents indirect locking by a third element, and thus reduces the quantity of elements, and facilitates the assembling. At the same time, the supporting wall is sandwiched between the first base plate and the second base plate, which enhances the bonding strength between the first base plate and the second base plate, prevents the switch layer sandwiched between the key and the second base plate from deformation, improves the trigger stability. In this way, the entire structure does not tend to be deformed, and the reliability is high.

### BRIEF DESCRIPTION OF THE DRAWINGS

In order to more clearly illustrate the technical solutions in the embodiments of the present invention, the drawings used in the description of the embodiments will be briefly described below. It is obvious that the drawings in the following description are only some embodiments of the present invention. For those skilled in the art, other drawings can be obtained according to these drawings without any creative work, wherein:

FIG. 1 is a perspective assembled view of a key unit according to a first embodiment of the present invention;

FIG. 2 is a perspective exploded view of the key unit shown in FIG. 1;

FIG. 3 is a side cross-sectional view of the key unit of FIG. 1 taken along line III-III;

FIG. 4 is a perspective enlarged view showing the assembly of the abutting body and the movable body shown in FIG. 1;

FIG. 5 is a perspective view showing the assembled structure of the elastic body and the movable body of the key unit shown in FIG. 2;

FIG. 6 is a perspective exploded view of the assembled structure shown in FIG. 5;

FIG. 7 is a schematic exploded perspective view of a key unit according to a second embodiment of the present invention;

FIG. 8 a side cross-sectional view of the assembled structure of the key unit shown in FIG. 7;

FIG. 9 is another perspective view of the structure shown in FIG. 7;

FIG. 10 is a schematic perspective structural view of a keyboard of the present invention;

FIG. 11 is a perspective exploded view of the keyboard of FIG. 10;

FIG. 12 is a perspective view showing the structure of the first substrate shown in FIG. 11; and

FIG. 13 is a side cross-sectional view of the assembled structure of the keyboard shown in FIG. 10.

### DETAILED DESCRIPTION

### First Embodiment

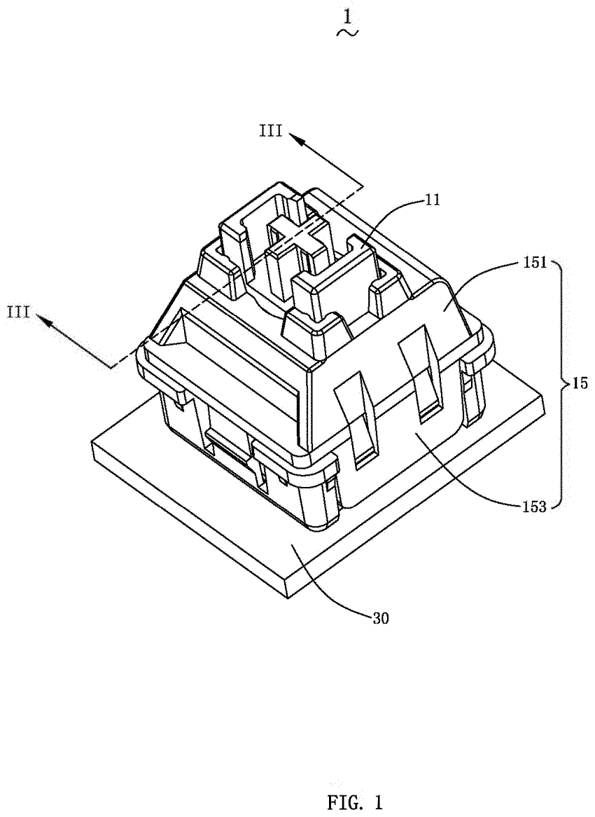

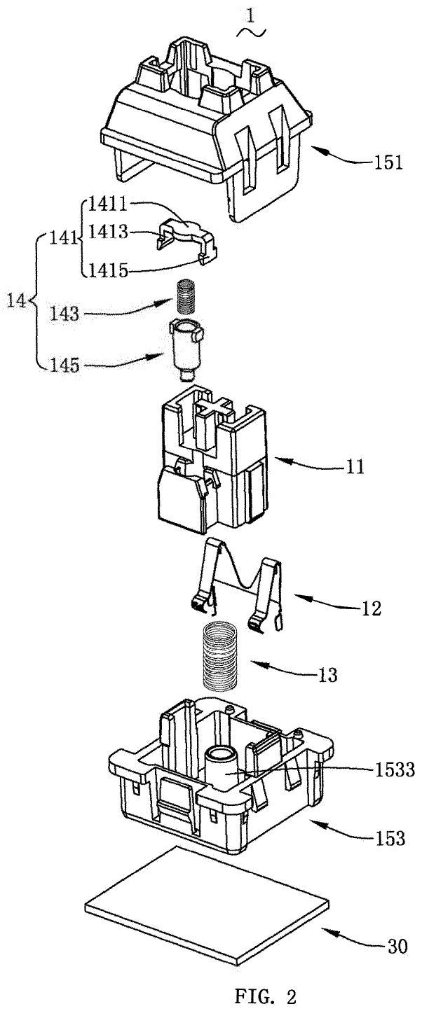

Simultaneously referring to FIG. 1 and FIG. 2, FIG. 1 is a schematic three-dimension assembling view of a key unit according to the present disclosure, and FIG. 2 is a schematic three-dimensional exploded view of the key unit as illustrated in FIG. 1. The key unit 1 is a switch conversion element configured to convert a physical press input signal into an electrical signal output. The switch layer 30 includes a plurality of control switches. When a user applies a vertical external force on the key unit 1, the key unit 1 correspondingly triggers one control switch of the switch layer 30, such that the key unit 1 is turned on and starts generating an input signal. When the user cancels the external force applied on the key unit 1, the key unit 1 is turned off, and the control switch of the switch layer 30 correspondingly stops generating the input signal.

The key unit 1 includes a movable body 11, an elastic plate 12, a first spring 13, an elastic body 14, and a housing 15 having a receiving space. The elastic body 14 includes a package 141, a second spring 143, and an abutting body 145. That is, the elastic body 14 is an elastic assembly formed by assembling the package 141, the second spring 143, and the abutting body 145. In a vertical direction, the elastic body 14 is disposed on a side surface of the movable body 11, and the elastic body 14 and a center position of the movable body are not in the same straight line direction.

In this embodiment, the elastic body 14 is an assembly formed by the second spring 143 in cooperation with other assembling elements. However, according to the design needs of the actual products and improvements of the technique, the elastic body 14 may also be an individual module unit or an individual element independently implementing the same function.

The movable body 11, the elastic plate 12, the first spring 13, and the elastic body 14 are correspondingly received in the receiving space of the housing 15. The package 141 of the elastic body 14 is correspondingly detachably fixed to the movable body 11, and moves upward and downward synchronously with the movable body 11. The second spring 143 is compressively sandwiched between the package 141 and the abutting body 145. The first spring 13 is compressively sandwiched between the housing 15 and the movable body 11. The first spring 13 is disposed under the movable body 11, and the second spring 143 is disposed on the side surface of the movable body 11.

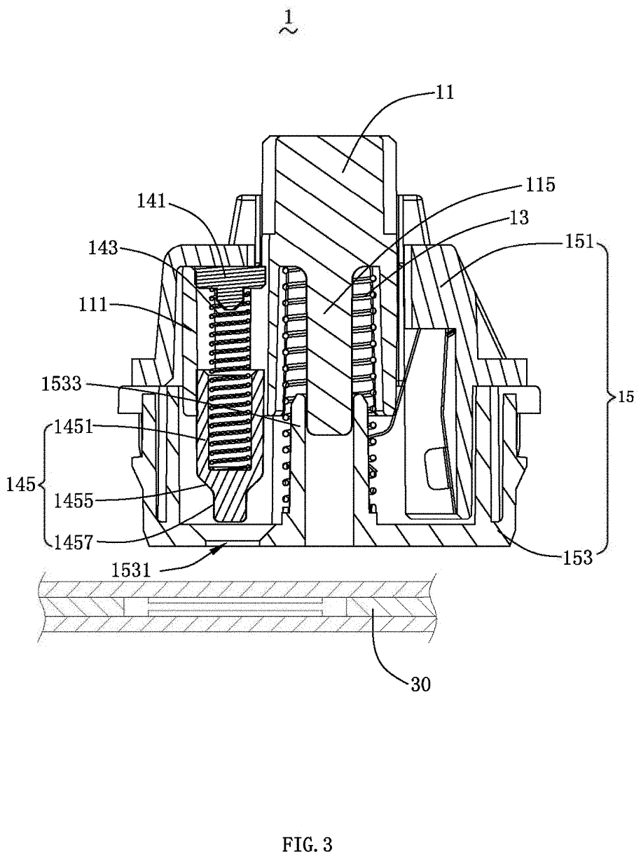

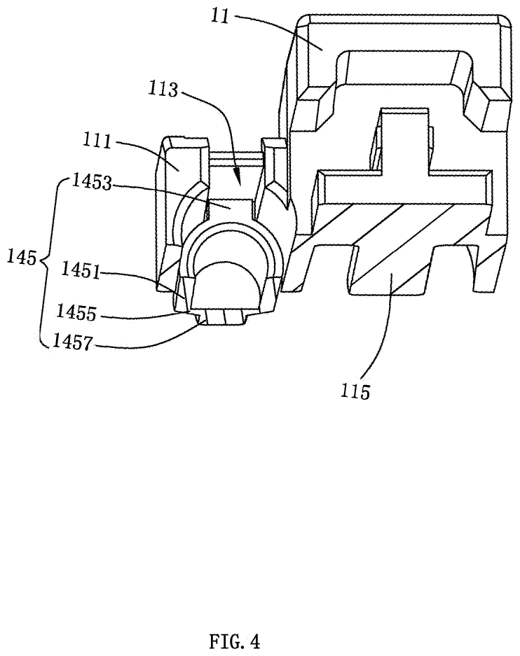

Referring to FIG. 3 and FIG. 4, FIG. 3 is a sectional view of the key unit as illustrated in FIG. 1 taken along line and is also a schematic partial structural view of an operating state of the key unit as illustrated in FIG. 1;

And FIG. 4 is a schematic enlarged three-dimensional view of assembling of an abutting body and a movable body as illustrated in FIG. 3. The movable body 11 is in an elongated columnar shape. One end of the movable body 11 is sleeved on a key cap (not illustrated in the drawings), and the other end of the movable body 11 is received in the receiving space of the housing 15. Under pressure by an external force, the movable body 11 moves downward along a vertical extension direction; and when the vertical external force is canceled, the movable body 11 correspondingly moves upward. The movable body 11 includes a side wall 111, a sliding groove 113, and a stroke guiding post 115. A top and a bottom of the side wall 111 are connected to enclose a hollow column. The hollow column is the receiving space configured to receive the second spring 143. The stroke guiding post 115 is disposed at the center position of the movable body 11. The hollow receiving space enclosed by the side wall 111 is disposed on an outer side of the stroke guiding post 115, that is, the side surface of the movable body 11. The first spring 13 is correspondingly disposed on the outer side of the stroke guiding post 115. A center of the first spring 13 is overlapped with a center of the stroke guiding post 115, that is, the first spring 13 is disposed at the center position of the movable body 11. During a specific manufacturing process of the product, the stroke guiding post 115 may also be disposed slightly eccentrically from the center position of the movable body 11, and correspondingly, the first spring 13 is also correspondingly sleeved onto the outer side of the stroke guiding post 115 and disposed slightly eccentrically under the movable body 11. In addition, the elastic body 14 and the stroke guiding post 115 are not disposed in the same straight line in the vertical direction. That is, the center of the elastic body 14 is not overlapped with the center of the stroke guiding post 115. The sliding groove 113 is correspondingly disposed one side wall 111. An extension direction of the sliding groove 113 is parallel to the extension direction of the hollow column enclosed by the side wall 111. In this embodiment, the side wall 111 is disposed on a side of the movable body 11.

The elastic plate 12 is disposed between the movable body 11 and the housing 15. The elastic plate 12 is elastically abutted against the side surface of the movable body 11 to control a tactile sensation when the movable body 11 is pressed to a suitable height. When the movable body 11 moves upward and downward in the vertical direction, friction is correspondingly generated with the elastic plate 12 and a sound tactile sensation is generated.

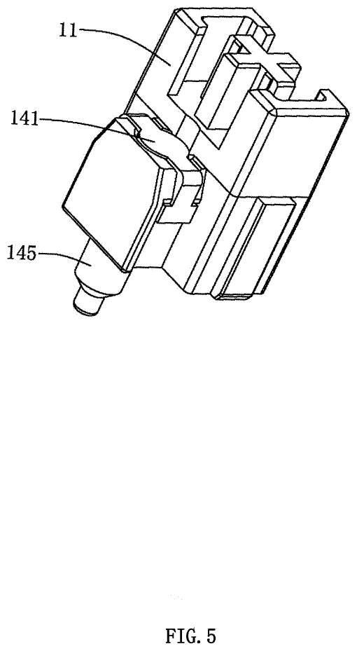

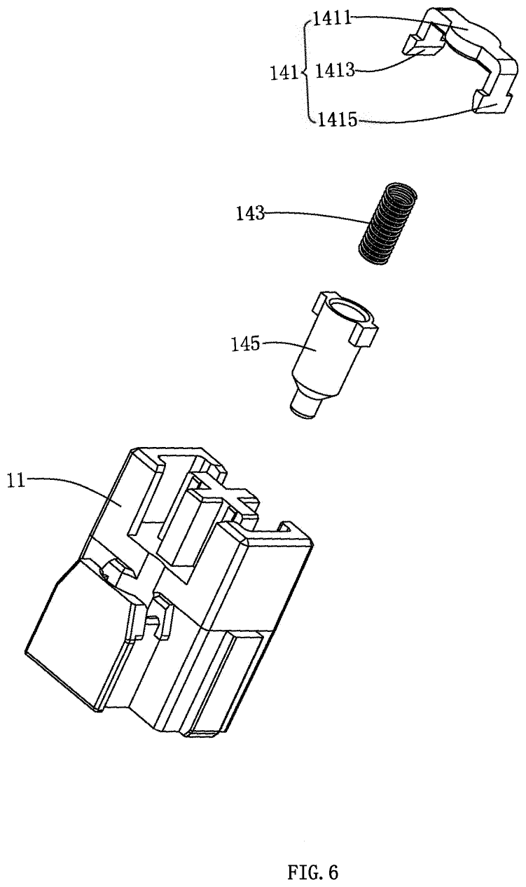

Referring to FIG. 5 and FIG. 6, FIG. 5 is a schematic three-dimensional view after the elastic body and the movable body of the key unit as illustrated in FIG. 2 are assembled, and FIG. 6 is a schematic three-dimensional exploded diagram of the assembled structure as illustrated in FIG. 5. The package 141 includes a cover 1411, a first clasp 1413, and a second clasp 1415. The first clasp 1413 and the second clasp 1415 are respectively symmetrically disposed on two opposite sides of the cover 1411. The first clasp 1413 and the second clasp 1415 are both disposed on the same side of the cover 1411. The first clasp 1413 and the second clasp 1415 are both in an inverted-T shape. The first clasp 1413 and the second clasp 1415 are respectively correspondingly clapped on the side wall 111 of the movable body 11. The cover 1411 is caused to correspondingly cover an end portion of the hollow columnar receiving space enclosed by the side wall of the movable body, such that a receiving space with one end being closed and the other end being opened. The second spring 143 is correspondingly received in the hollow columnar receiving space, and an end portion of the second spring 143 is correspondingly abutted against an inner side surface of the cover 1411. When the movable body 11 moves upward and downward, correspondingly, since the package 141 is correspondingly latched and fixed to the side wall 111, the package 141 and the movable body 11 are synchronously movable upward and downward.

The abutting body 145 is integrally in a columnar shape. One end of the abutting body 145 is nested and received in the side wall 111 and in cooperation with the opening of the receiving space enclosed by the cover 1411. The abutting body 145 includes a side wall 1451, a sliding block 1453, a connecting portion 1455, and an abutting portion 1457. The side wall 1451 encloses a hollow receiving space, and an outer profile of a receiving space enclosed by the side wall of the abutting body 145 is less than an inner profile of the receiving space enclosed by the side wall 111 of the movable body 11. The side wall of the abutting body 145 and the side wall of the movable body 11 are nested. In this embodiment, the side wall 1451 of the abutting body 145 is correspondingly received in the receiving space enclosed by the side wall 111 of the movable body 11. Since an outer profile of the side wall 1451 of the abutting body 145 is less than an inner profile of the side wall 111 of the movable body 11, the abutting body 145 correspondingly freely moves upward and downward along the extension direction of the side wall 111 relative to the receiving space enclosed by the side wall 111 of the movable body 11.

The sliding block 1453 is disposed on a side surface of the side wall 1451, and is formed by extending from the side wall 1451 towards a direction perpendicular to the side wall 111. The sliding block 1453 is corresponding nested in the sliding groove 113. When the abutting body 145 moves upwards and downwards relative to the movable body 11, the sliding block 1453 synchronously moves upward and downward along the sliding groove 113. The sliding block 1453 and the sliding groove 113 are assembled and cooperated, such that the abutting body 145 moves upward and downward in a vertical direction along a direction parallel to the sliding groove 113.

The connecting portion 1455 is connected to the abutting portion 1457 and the side wall 1451. The connecting portion 1455 is integrally in a frusto-conical shape, and an outer surface of the connecting portion 1455 connects, in a slope transition fashion, the side wall 1451 to the abutting portion 1457. An outer diameter profile of the abutting portion 1457 is less than an outer diameter profile enclosed by the side wall 1451.

The abutting portion 1457 is manufactured from a plastic material, and an end portion of the abutting portion 1457 is abutted against the switch layer 30. The abutting portion 1457 is selectively pressed against and drives the switch layer 30 to be turned on or turned off. The term “selectively” herein means that depending on whether an external force is applied and a magnitude of the external force, the abutting portion 1457, correspondingly in one operating state, is pressed against and abutted against the switch layer 30 and provides a sufficient pressure to drive the switch layer 30 to be in a turned-on state. Correspondingly, the abutting portion 1457 is correspondingly in another operating state, the abutting portion 1457 is separated from the switch layer 30 or in a pre-tensioned state where no sufficient pressure is provided, such that the switch layer 30 is in a turned-off state. The second spring 143 is a metal spring, and the second spring 143 is elastically received between the package 141 and the abutting portion 145. One end of the second spring 143 is abutted against the inner side surface of the cover 1411, and the other end of the second spring 143 is abutted against an inner side surface of the abutting portion 1457. In normal states, the second spring 143 is in a natural state or a pre-tensioned state.

Heretofore, the package 141, the second spring 143, and the abutting body 145 collaboratively constitute the elastic body 14 of the key unit 1. The elastic body 141 is combined to practice switching between different operating states where the movable body 11 of the key unit 1 is correspondingly selectively abutted against the switch layer 30, such that turn-on or turn-off of the switch layer 30 is controlled.

As a further improvement of the above embodiment, the elastic body 14 may also be an assembly constituted by an integrally molded silica gel in place of the abutting body 145, and the second spring 143.

Further, the elastic body 14 and the movable body 11 may also be integrally molded by a double injection molding process, and the elastic body 14 may be made from either of a silica gel or a polyacetal resin.

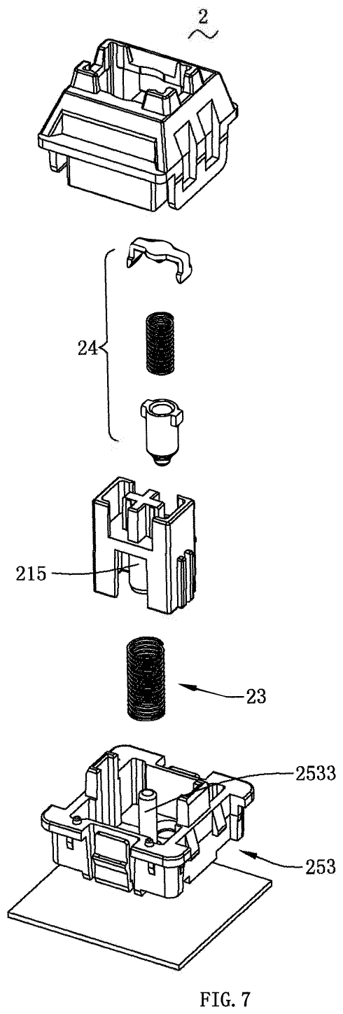

Referring to FIG. 7, when the elastic body 14 is assembled by the following steps:

receiving the abutting body 145 in the receiving space disposed on the side wall 111 of the movable body 11 and having the opening, wherein the sliding block 1453 is correspondingly nested and received in the sliding groove 113, and is movable upward and downward along an extension direction of the sliding groove 113;

receiving the second spring 143 in the abutting body 145, wherein one end of the second spring 143 is abutted against the abutting body 145, and the other end of the second spring 143 is received in the receiving space having the opening; and

providing the package 141, wherein the opening of the receiving space is covered by the package 141, and the spring is packaged in the package 141.

Still referring to FIG. 1, FIG. 2, and FIG. 3, the housing 15 includes an upper cover 151 and a lower cover 153 that are correspondingly latched and fixed to each other. The upper cover 151 and the lower cover 153 are correspondingly latched to each other to enclose a receiving space configured to receive the movable body 11, the elastic plate 12, the first spring 13, and the elastic body 14. The lower cover 153 includes a through hole 1531 and a stroke guiding tube 1533. The through hole 1531 corresponds to the abutting portion 1457 of the abutting body 145. When the abutting body 145 moves downward, correspondingly, the abutting portion 1457 passes through the through hole 1531. The stroke guiding tube 1533 and the stroke guiding post 115 are nested and assembled, and the stroke guiding post 115 is slidable upward and downward relative to the stroke guiding tube 1533. The first spring 13 is sleeved onto the outer sides of the stroke guiding post 115 and the stroke guiding tube 1533, one end of the first spring 13 is abutted against the movable body 11, and the other end of the first spring is elastically abutted against the lower cover 153. The first spring 13 is compressively sandwiched between the movable body 11 and the lower cover 153.

The key unit 1 is assembled by the following steps:

first, providing the movable body 11 and the abutting body 145, wherein the movable body 11 includes a receiving space, the abutting body 145 is received in the receiving space of the movable body 11, and the sliding block 1453 of the abutting body 145 and the sliding groove 113 are correspondingly nested and assembled;

second, providing the second spring 143 and the package 141, wherein the abutting body 145 is in cooperation with the package 141 and the side wall 111 of the movable body 11 to enclose a receiving space configured to compressively receive the second spring 143 therein, the first clasp 1413 and the second clasp 1415 of the package 141 are correspondingly latched and fixed to the side wall 111 of the movable body 11, and one end of the receiving space is provided with an opening, such that the second spring 143 is correspondingly received between the abutting body 145 and the package 141;

further, providing the elastic plate 12, the first spring 13, and the upper cover 151, wherein the movable body 11 and the upper cover 151 are both inverted, the elastic plate 12 is sandwiched between the upper cover 151 and the side surface of the movable body 11, and the first spring 13 is sleeved onto the outer side of the stroke guiding post 115; and

finally, providing the lower cover 153, wherein the abutting portion 1457 of the abutting body 145 corresponds to the through hole 1531 of the lower cover 153, the lower cover 153 is inverted and latched on the upper cover 151, and the lower cover 153 and the upper cover 151 are latched and fixed to each other.

Heretofore, the assembling of the key unit 1 is completed.

The key unit 1 operates in compliant with the following principles: An operator applies a vertical pressure onto the end portion of the movable body 11, the movable body 11 moves downward, when the abutting body 1457 is abutted against the switch layer 30, the sliding block 1453 slides upward along the extension direction of the sliding groove 113, and the elastic body 14 is correspondingly selectively pressed against the switch layer 30. Since the second spring 143 is in the natural state or the pre-tensioned state, when the movable body 11 moves downward, the package 141 is driven to synchronously move downward, the abutting portion 1457 of the abutting body 145 passes through the through hole 1531 and is elastically abutted against the switch layer 30, and the abutting portion 1457 exerts a pressure against the switch layer 30 to push the control switches of the switch layer 30 to be in the turned-on state. On the contrary, when the external force is canceled, under the effect of a counterforce from the first spring 13, the movable body 11 moves upward, the abutting body 145 also moves upward, the sliding block 1453 moves downward along the sliding groove 113, the abutting portion 1457 leaves from the switch layer 30, the switch layer 30 is turned off when the pressure decreases and disappears, the second spring 143 restores to an original state, and the movable body 11 rebounds to the position before the press.

In this manner, the key unit 1 is switched between two operating states, the turned-on state and the turned-off state.

In the key unit 1, the stroke guiding post 115 and the first spring 13 are disposed under the movable body 11 or at a slight eccentric position thereof. When the movable body 11 is pressed, correspondingly, a vertical downward force is generated to push the first spring 14 to retract; and when the press force is canceled, the first spring 13 correspondingly generates a vertical counterforce to push the stroke guiding post 115 and the movable body 11 to move upward in the vertical direction. During this process, the vertical counterforce is generated to push the movable body to move upward or downward in the vertical direction, such that the defects such as inclination and jamming of the movable body caused by force components generated in the horizontal direction are addressed, and the press smoothness in the vertical direction is improved.

As a further improvement of the above embodiment, the second spring 143 is not merely limited to a spring, but may be another elastic element. Any medium capable of providing a buffer force which satisfies the elastic abutment between the key unit 1 and the switch layer 30 shall be all within the inventive concept of the present disclosure, and shall likewise or equivalently fall within the protection scope of the present disclosure.

As compared with the related art, the key unit 1 according to the present disclosure achieves the following beneficial effects:

First, the side wall 111 of the movable body 11 is in cooperation with the package 141 of the elastic body 14 to enclose a receiving space configured to receive the second spring 143 and the end portion of the abutting body 145, which effectively achieves a dust-proofing effect.

Then, the side wall 111 of the movable body 11 is directly used as a stroke guiding support for the abutting body 145, which simplifies the structure, reduces the quantity of elements, and facilitates the assembling.

Still further, since the movable body 11 and the side wall 111 thereof are integrally molded, the abutting body 145 may be effectively supported by the movable body 11, which improves the product reliability.

Finally, the elastic body 14 is disposed on the side surface of the stroke guiding post 115, which addresses the defect of jamming of the movable body 11, provides an upward force or a downward force in the vertical direction, improves the smoothness, facilitates the assembling, and improves the product reliability.

In addition, the present disclosure further provides an input device, such as a keyboard and a remote control, which employs arrays of the key units 1 as illustrated in FIG. 1.

### Second Embodiment

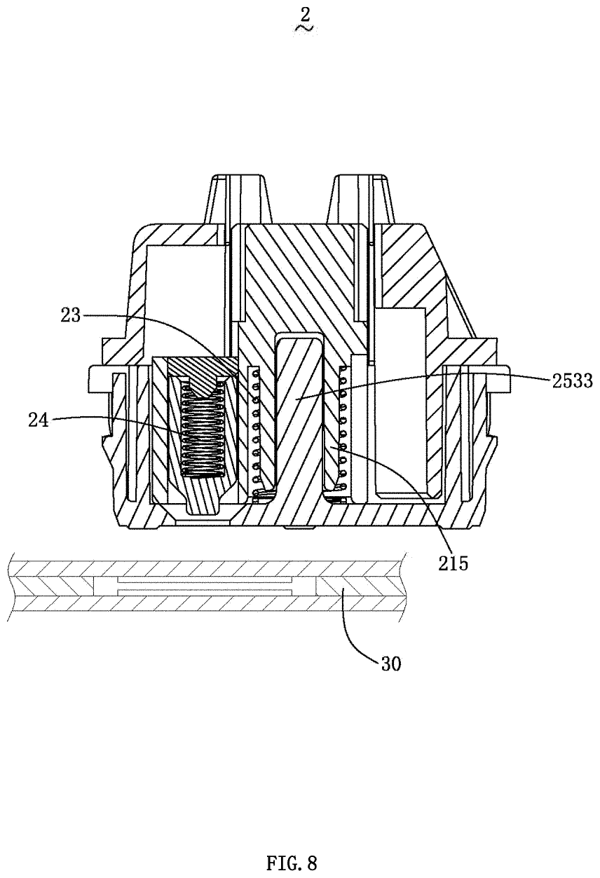

Referring to FIG. 7 and FIG. 8, FIG. 7 is a schematic three-dimensional exploded view of a key unit according to a second embodiment of the present disclosure, and FIG. 8 is a side sectional view after the key units as illustrated in FIG. 7 is assembled. The key unit 2 is substantially the same as the key unit 1 in the above embodiment, but is slightly different as follows:

The movable body 21 includes a stroke guiding tube 215, and the lower cover 253 includes a stroke guiding post 2533. The stroke guiding tube 215 of the movable body 21 and the stroke guiding post 2533 of the lower cover 253 are correspondingly nested, wherein the stroke guiding post 2533 of the lower cover 253 is received in the stroke guiding post 215 of the movable body 21, and in a vertical direction, the stroke guiding post 215 and the stroke guiding post 2533 are movable upward and downward relative to each other.

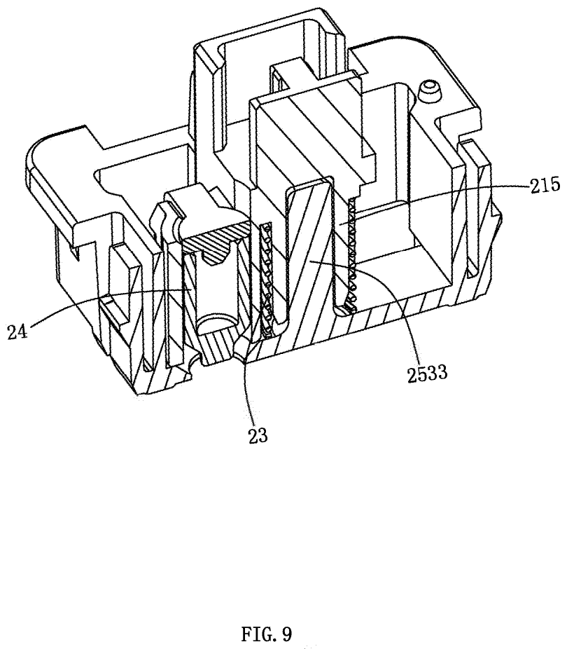

As illustrated in FIG. 9, the first spring 23 is sleeved on an outer side of an assembly formed after the stroke guiding tube 215 and the stroke guiding post 2533 are assembled.

Likewise, the elastic body 24 is disposed on the side surface of the movable body 21, which is different from the position where the stroke guiding post 2533 and the stroke guiding tube 215 are combined. That is, the position of the elastic body 24 and the position of the stroke guiding post 2533 and the stroke guiding tube 215 are not on the same axis.

The key unit 2 is assembled by the following steps:

step S01: providing a movable body 21, wherein the movable body 21 includes stroke guiding tube 215;

step S02: providing a first spring 23, wherein the first spring 23 is sleeved onto an outer side of the stroke guiding tube 215; and

step S03: providing a lower cover 253, wherein the lower cover 253 includes a stroke guiding post 2533, wherein the stroke guiding post 2533 is nested and assembled corresponding to a central region of the stroke guiding tube 215, such that the first spring 23 is sleeved onto the outer sides of the stroke guiding post 2533 and the stroke guiding tube 215. In this embodiment, the stroke guiding tube 215 is disposed in a central region inside the key, which prevents dust accumulation due to direct contact with the extremal stuffs, and improves the dust-proofing performance. In addition, the stroke guiding post 2533 is in cooperation with the stroke guiding tube 215 such that the movable body 21 is supported upward or downward in the vertical direction, and inclinations due to upward and downward movements, and jamming or force dispersion caused thereby are prevented, which improves the smoothness and tactile sensation, enhances the reliability of the key unit 2, and prolongs the life time.

### Third Embodiment

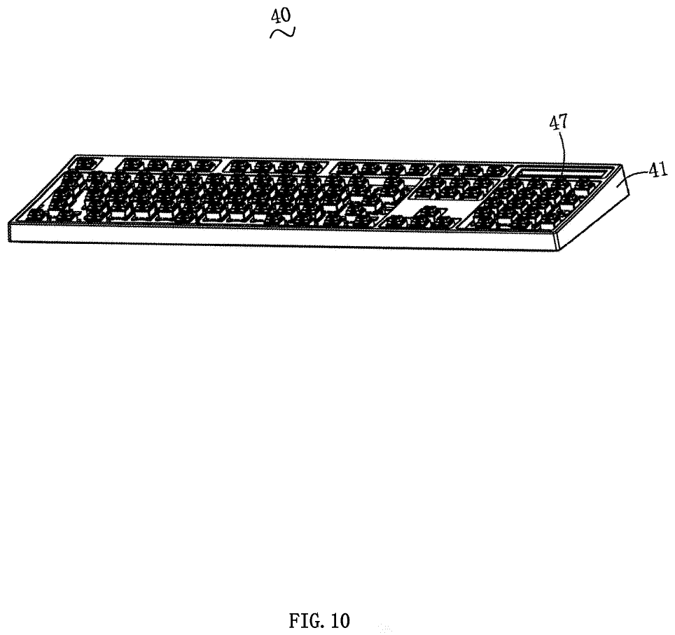

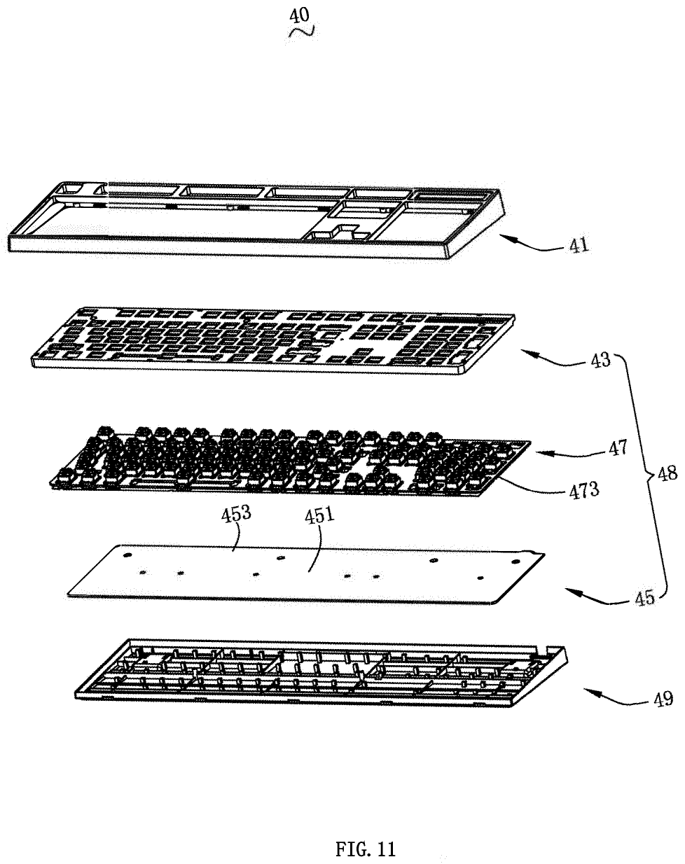

Simultaneously referring to FIG. 10 and FIG. 11, FIG. 10 is a schematic three-dimension assembling view of a key unit according to the present disclosure, and FIG. 11 is a schematic three-dimensional exploded diagram of the key unit as illustrated in FIG. 10. The key board 40 includes a first housing 41, a first base plate 43, a second base plate 45, a plurality of key units 47, and a second housing 49. The first housing 41 is in cooperation with the second housing 49 to enclose a receiving space configured to correspondingly receive the first base plate 43, the second base plate 45, and the key units 47. The keyboard 40 may be an input device of a telephone, a mobile phone, a remote control, a laptop computer, or a desktop computer, or may be another electronic product input device having a key structure. The first base plate 43, the second base plate 45, and the plurality of key units 47 that are arrayed collaboratively form a key array module 48. The key array module 48 is correspondingly received in the receiving space enclosed by the first housing 41 and the second housing 49. The key units 47 may be at least the key units 1 and 2 as disclosed in the first embodiment and the second embodiment. Nevertheless, the key units 47 may also be other key units. Any individual key units which form the input device by employing the housing and the base plates to support the key units may be considered as the key units disclosed or supported by the present disclosure. All these key units shall be considered as falling within the same inventive concept as the present disclosure.

The first base plate 43 and the second base plate 45 are spacedly laminated in a top-to-bottom opposing fashion, and latched and fixed to form an integral assembly. The plurality of key units 47 are arrayed, and one end of each of the plurality of key units 47 passes through the first base plate 43 and approaches an inner side surface of the second base plate 45. The first base plate 43, the second base plate 45, and the plurality of key units 47 that are arrayed are assembled to form the key array.

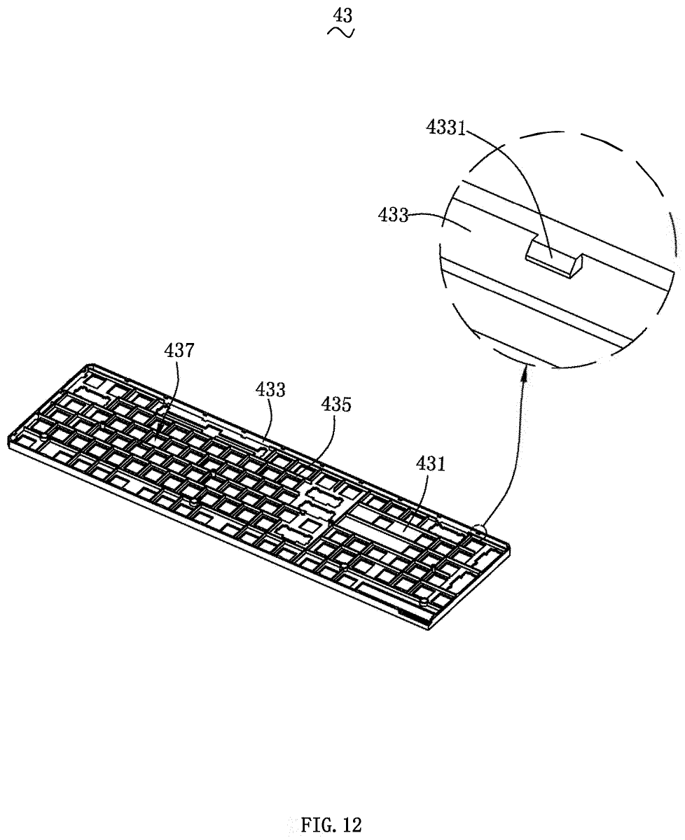

Referring to FIG. 12, FIG. 12 is a schematic three-dimensional structural diagram of the first base plate as illustrated in FIG. 11. The first base plate includes a body 431, a side wall 433, a supporting wall 435, and a plurality of arrayed through holes 437.

The body 431 is integrally in a rectangular flat plate shape, and the through holes 437 are disposed on a surface of the body 431.

The side wall 433 is formed by extending from an edge of the body 431 towards the second base plate 45, and a head and a tail of the side wall 433 are connected to enclose an opening (not illustrated in the drawings) facing towards the second base plate 45. An inner side surface of the side wall 433 distal from the body 431 is provided with a plurality of clasps 4331.

An inner diameter profile of the through holes 437 is matched with an outer diameter profile of the key units 47, and the key units 47 are correspondingly received and supported in the through holes 437. The supporting wall 435 is formed by extending from the surface of the body 431 towards the second base plate 45. The supporting wall 435 and the body 431 may be integrally molded once by an injection molding process. The supporting walls 435 are arrayed by surrounding a periphery of the through hole 437. Specifically, the through hole 437 may be a square hole or a circular hole, which allows the key unit 47 to conveniently pass therethrough.

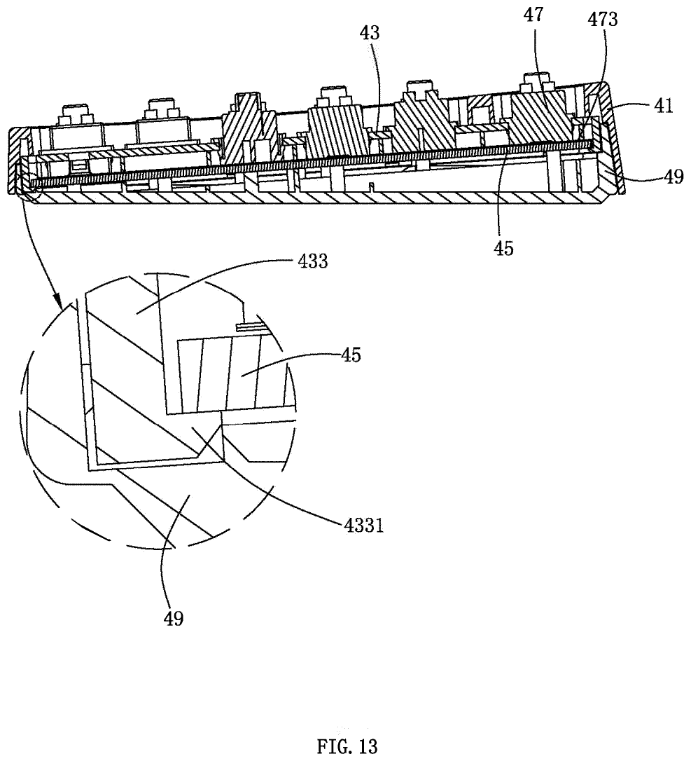

Referring to FIG. 11 and FIG. 13, FIG. 11 is a schematic three-dimensional exploded view of the key unit as illustrated in FIG. 10, and FIG. 13 is a side sectional view after the keyboard as illustrated in FIG. 10 is assembled. The second base plate 45 includes a bottom plate 451 and an edge 453. The bottom plate 451 is integrally in a flat plate shape, disposed relative to the body 431 of the first base plate 43, and covers the opening enclosed by the side wall 433 of the first base plate 43. The edge 453 is disposed by surrounding the bottom plate 451. When the second base plate 45 and the first base plate 43 are assembled, the clasp 4331 is correspondingly abutted against the edge 453, and correspondingly wraps an outer side surface of the bottom plate 451. In this way, the second base plate 45 and the first base plate 43 are latched and fixed.

A plurality of key units 47 may be provided, which are arranged to an array. Each of the plurality of key units 47 corresponds to a through hole in the first base plate 43. The key unit 47 passes through the through hole 437, and two ends of the key unit 47 are respectively on two ends of the first base plate 43. One end of the key unit 47 is abutted against or approaches an inner side surface of the second base plate 45, and the other end of the key unit 47 extends out of the through hole 437 towards a direction going away from the second base plate 45. The key unit 47 may be the key unit 1 or the key unit 2 as illustrated in the first embodiment or the second embodiment. The switch layer 473 is sandwiched between the first base plate 43 and the second base plate 45, and a surface of the switch layer 473 is abutted against the supporting wall 435 of the first base plate 43, such that the switch layer 473 is smoothly attached on a surface of the bottom plate 451 of the second base plate 45. When an input operation is to be performed, an external force in the vertical direction is applied to press one end of the key unit 47. When the press stroke goes downward to a predetermined value, the key unit 47 triggers the control switches of the switch layer 473 to be turned on. On the contrary, when the press stroke goes upward such that the abutting body of the key unit 47 is separated from the switch layer 473, the key unit 47 is turned off, and input is stopped.

Referring to FIG. 13, FIG. 13 is a side sectional view after the keyboard as illustrated in FIG. 10 is assembled. The first base plate 43 and the second base plate 45 are spaced apart in an opposing fashion, and the supporting wall 435 of the first base plate 43 is sandwiched between the body 431 of the first base plate 43 and the bottom plate 451 of the second base plate 45 to support a spacing height between the first base plate 43 and the second base plate 45, maintain spacing uniformity, consistency, and stability therebetween. The clasp 4331 of the first base plate 43 and the edge 453 of the second base plate 45 are correspondingly latched and assembled. Since the edge 453 and the second base plate 45 are integrally molded, when the clasp 4331 and the edge 453 are latched, the first base plate 43 and the second base plate 45 are correspondingly assembled and fixed.

When the keyboard 40 is being assembled, the first base plate 43 and the second base plate 45 are assembled and fixed to each other by physical bonding between the clasp 4331 and the edge 453, which prevents use of an additional fixing element, reduces the quantity of elements, and facilitates assembling.

The supporting wall 435 is sandwiched between the first base plate 43 and the second base plate 45, and the switch layer 473 is tightly pressed by virtue of the supporting wall 435, such that the switch layer 473 is smoothly attached on the surface of the second base plate 45, which maintains the smoothness of the switch layer 473 from deformation, improves lamination consistency between the switch layer 473 and the key unit 47, and improves the trigger reliability of the key unit 47.

In another aspect, since the supporting walls 435 are arrayed, by virtue of the support effect of the supporting walls 435, the spacing uniformity between the first base plate 43 and the second base plate 45 is maintained. Even if a greater external force is applied to the keyboard 40, the spacing between the first base plate 43 and the second base plate 45 tends to be stable, which reduces the possibility that the keyboard 40 is integrally deformed.

Nevertheless, as a further improvement of the above embodiment, the latching between the first base plate 43 and the second base plate 45 is not limited to the above fashion. Instead, the first base plate 43 and the second base plate 45 may also be latched to each other by a clasp or a bump. The clasp may also be directly disposed on the second base plate. Any assembling and fixing fashion by virtue of the inherent structures of the two base plates shall be considered as falling within the inventive concept of the present disclosure.

Further, the clasp 4331 is not limited to the clasp itself, which may also be another assembling structure that bonds and fixes the side wall 433 to the second base plate 45, for example, a hook, a bump, or a slot. Any fixing structure that helps to effectively fixes the first base plate 43 to the second base plate 45 shall be considered as falling within the inventive step of the present disclosure.

As compared with the related art, with the keyboard 40 according to the present disclosure, the quantity of elements is reduced, the structure is simplified, the assembling is facilitated, and the product reliability is improved.

Described above are exemplary embodiments of the present disclosure, but are not intended to limit the scope of the present disclosure. Any equivalent structure or equivalent process variation made based on the specification and drawings of the present disclosure, which is directly or indirectly applied in other related technical fields, fall within the scope of the present disclosure.

What is claimed is:

1. A key unit, comprising:
a movable body;
an elastic body; and
a switch layer comprising a plurality of control switches that are arrayed, wherein along a vertical direction, one end of the elastic body is abutted against a non-central region of the movable body, the other end of the elastic body is selectively pressed against the switch layer under pressing drive of the movable body to adjust an operating state of the control switches of the switch layer.

2. The key unit according to claim 1, wherein the movable body comprises the stroke guiding post and the side wall, and in the vertical direction, the stroke guiding post is disposed at a center position of the movable body or at a slightly off-center position, and the side wall encloses a receiving space with an opening, the receiving space being disposed on an outer side of the stroke guiding post, the elastic body being movably nested at the opening;
the key unit comprising a housing, wherein the housing comprises a stroke guiding tube, the stroke guiding tube and the stroke guiding post being correspondingly nested and freely slidable upward and downward relative to each other.

3. The key unit according to claim 1, wherein the movable body comprises the stroke guiding tube and the side wall, and in the vertical direction, the stroke guiding tube is disposed at a center position of the movable body or at a slightly off-center position, and the side wall encloses a receiving space with an opening, the receiving space being disposed on an outer side of the stroke guiding tube, the elastic body being movably nested at the opening;
the key unit comprising a housing, wherein the housing comprises a stroke guiding post, the stroke guiding post and the stroke guiding tube being correspondingly nested and freely slidable upward and downward relative to each other.

4. The key unit according to claim 2, wherein the elastic body comprises a spring and an abutting body, the spring being received in the receiving space enclosed by the side wall, one end of the spring being elastically abutted against the abutting against, the abutting body being selectively pressed against the switch layer.

5. The key unit according to claim 4, wherein the abutting body comprises a side wall, a connecting portion, and an abutting portion that are connected, the side wall of the abutting body and the side wall of the movable body being nested, the abutting portion being selectively pressed against the switch layer.

6. The key unit according to claim 4, wherein the elastic body further comprises a package, the package comprising a cover, a first clasp, and a second clasp, the first clasp and the second clasp being respectively disposed on two opposite sides of the cover, the first clasp and the second clasp being correspondingly latched and fixed to the side wall of the movable body, the package being in cooperation with the side wall of the movable body to enclose a receiving space with an opening, the elastic body being correspondingly received in the receiving space, one end of the elastic body being abutted against an inner side surface of the cover of the package.

7. The key unit according to claim 2, wherein the side wall of the movable body comprises a sliding groove, and the abutting body comprises a sliding block, the sliding block being disposed on a side surface of the abutting body, the sliding block being in cooperation with the sliding groove to push the abutting body to move upward and downward along an extension direction of the sliding groove.

8. The key unit according to claim 2, wherein the housing comprises an upper cover and a lower cover that are latched and fixed to each other, the lower cover comprising a through hole, the abutting portion of the abutting body passing through the through hole and being selectively pressed against the switch layer.

9. The key unit according to claim 2, further comprising an elastic plate, wherein the elastic plate is sandwiched between the first movable body and the housing.

10. The key unit according to claim 3, wherein the elastic body comprises a spring and an abutting body, the spring being received in the receiving space enclosed by the side wall, one end of the spring being elastically abutted against the abutting against, the abutting body being selectively pressed against the switch layer.

11. The key unit according to claim 10, wherein the abutting body comprises a side wall, a connecting portion, and an abutting portion that are connected, the side wall of the abutting body and the side wall of the movable body being nested, the abutting portion being selectively pressed against the switch layer.

12. The key unit according to claim 10, wherein the elastic body further comprises a package, the package comprising a cover, a first clasp, and a second clasp, the first clasp and the second clasp being respectively disposed on two opposite sides of the cover, the first clasp and the second clasp being correspondingly latched and fixed to the side wall of the movable body, the package being in cooperation with the side wall of the movable body to enclose a receiving space with an opening, the elastic body being correspondingly received in the receiving space, one end of the elastic body being abutted against an inner side surface of the cover of the package.

13. The key unit according to claim 3, wherein the side wall of the movable body comprises a sliding groove, and the abutting body comprises a sliding block, the sliding block being disposed on a side surface of the abutting body, the sliding block being in cooperation with the sliding groove to push the abutting body to move upward and downward along an extension direction of the sliding groove.

14. The key unit according to claim 3, wherein the housing comprises an upper cover and a lower cover that are latched and fixed to each other, the lower cover comprising a through hole, the abutting portion of the abutting body passing through the through hole and being selectively pressed against the switch layer.

15. The key unit according to claim 3, further comprising an elastic plate, wherein the elastic plate is sandwiched between the first movable body and the housing.

16. A keyboard, comprising a first base plate and a second base plate each having a plurality of through holes, and a plurality of key units, the first base plate and the second base plate being spaced apart from each other, the key units being abutted against or approaching an inner side surface of the second base plate by the through holes, wherein the key unit comprises the key unit as defined in claim 1, and the first base plate comprises a side wall, the side wall being fixed to an edge of the second base plate by a clasp structure.

17. The keyboard according to claim 16, wherein the key unit comprising a housing, the movable body and the housing being assembled under cooperation of a stroke guiding post and a stroke guiding tube such that the movable body is movable upward and downward in a vertical direction relative to the housing.

18. The keyboard according to claim 17, wherein the stroke guiding post is disposed on the movable body, and the stroke guiding tube is disposed on the housing.

19. The keyboard according to claim 17, wherein the stroke guiding post is disposed on the housing, and the stroke guiding tube is disposed on the movable body.

20. The keyboard according to claim 16, wherein the first base plate further comprises a supporting wall, the supporting wall being sandwiched between the body of the first base plate and the second base plate.
